(19) United States
(12) Patent Application Publication
(10) Pub. No.: US 2018/0101392 A1
(43) Pub. Date: Apr. 12, 2018

(54) AUTO-CONFIGURABLE HOST PLUGGABLE COMPUTING

(71) Applicant: Intel Corporation, Santa Clara, CA (US)

(72) Inventors: Yen Hsiang Chew, Penang (MY); Eng Choon Tan, Penang (MY)

(21) Appl. No.: 15/290,325

(22) Filed: Oct. 11, 2016

(51) Int. Cl. G06F 9/445; G06F 9/44

(52) U.S. Cl. CPC G06F 9/44505; G06F 9/4406

(57) ABSTRACT

Apparatuses, methods and storage medium associated with auto-configurable host pluggable computing, are disclosed herein. In embodiments, a user defined configuration parameters may be stored in a host system. When a pluggable computing device is connected to the host system; the pluggable computing device may read the configuration parameters from the host system and store the configuration parameters in a non-volatile memory region; and then reconfigure itself or the host system based on the configuration parameters. Other embodiments may be described and/or claimed.

### TECHNICAL FIELD

The present disclosure relates to the field of computing. More particularly, the present disclosure relates to methods and apparatuses associated with auto-configurable host pluggable computing.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Conventionally, a pluggable computing system has fixed Input/Output (IO) mappings between the host system and the pluggable module's IO interface. In some embodiments, reconfiguring of IO pins may be required to enable the combined system to operate together. Other reconfigurations may be required for the combined system to operate efficiently.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 shows a component view of the auto-configurable host pluggable computing technology of the present disclosure, according to various embodiments.

FIG. 2 shows a method view of the auto-configurable host pluggable computing, according to various other embodiments.

FIG. 3 illustrates an example computer system suitable for practicing various aspects of the present disclosure, according to various embodiments.

FIG. 4 illustrates a storage medium having instructions for practicing methods described with references to FIGS. 1-2, according to various embodiments.

### DETAILED DESCRIPTION

Apparatuses, methods, and storage medium associated with auto-configurable host pluggable computing are disclosed herein. In embodiments, the technology provides a method for a pluggable computing module to detect the configuration requirements of its host system when the pluggable computing module is dynamically plugged into the host system; and reconfigure itself to match the configuration requirements of its host system for optimum power, system performance, IO compatibility, and so forth.

In embodiments, a user defined configuration parameters may be stored in a host system. When a pluggable computing device may be connected to (plugged into) the host system; the pluggable computing device may read the configuration parameters from the host system and stores the configuration parameters in a non-volatile memory region; and then reconfigures itself based on the configuration parameters by invoking a platform sub-system reset or system reboot. Upon reset or system reboot; pluggable computing device firmware or BIOS may inspect configuration parameters stored in the non-volatile memory region for host system requirements and use this information to guide the platform configuration process or the boot sequence in order to optimize operation of the pluggable computing device or the host system.

In the description to follow, references will be made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a programmable logic device (e.g. a field programmable gate array), a processor (shared, dedicated, or group) and/or memory (shared, dedicated, or group) that execute one or more software or firmware programs having machine instructions (generated from assembler instructions or compiled from higher level language instructions), a combinational logic circuit, and/or other suitable components that provide the described functionality.

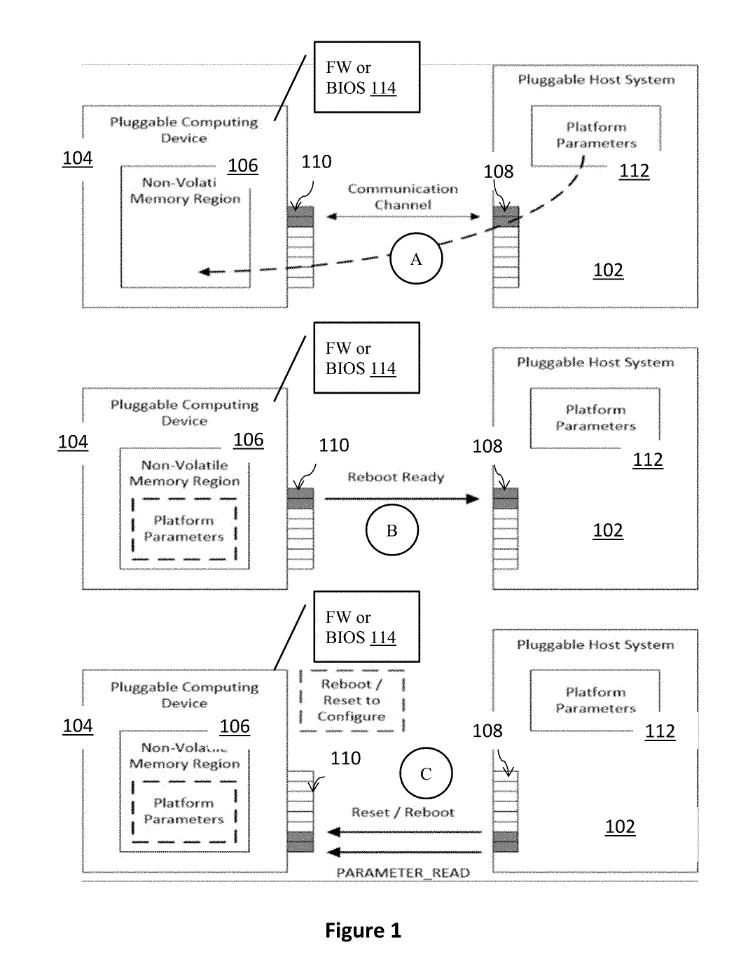

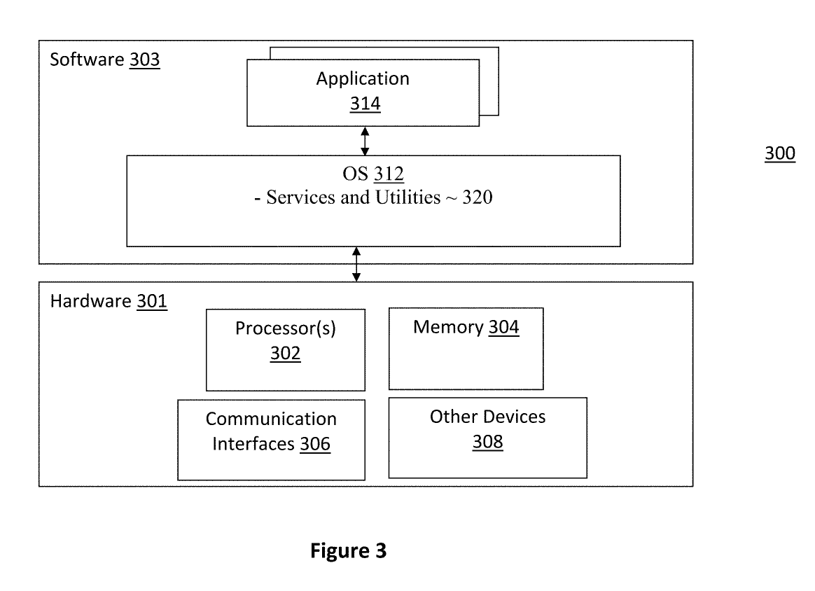

Referring now to FIG. 1, wherein a component view of the auto-configurable host pluggable computing technology of the present disclosure, according to various embodiments, is shown. As illustrated, pluggable host system 102 may include user defined platform configuration parameters 112 stored therein (hereinafter, simply configuration parameters). An example of pluggable host system 102 may include a pluggable display panel or a pluggable embedded computing system (e.g. a kiosk). Pluggable computing device 104 may include firmware (FW) or BIOS 114 incorporated with the auto-configurable host pluggable computing technology of the present disclosure. Examples of pluggable computing device 104 may include pluggable computing module based on Intel's Open Pluggable Specification (OPS), a graphics processor unit (GPU) card, a compute stick, a processor on a Peripheral Component Interconnect (PCI) Express processor card module (e.g. Intel's Xeon Phi processors) . . . ). When plugged together, pluggable computing device 104 and pluggable host system 102 may form a computing system, e.g., system 300 of FIG. 3.

Further, pluggable computing device 104 and pluggable host system 102 may respectively include corresponding portions of a physical interconnect interface 110 and 108 (e.g., corresponding portions of a PCI Express interface). For ease of understanding, the remainder of the description will be presented with PCI Express as the physical interconnect interface between pluggable computing device 104 and pluggable host system 102. However, the present disclosure is not so limited, it is also applicable to other types of physical interconnects (e.g. Universal Serial Bus (USB), Dual in-Line Memory Module/Small Outline Dual in-Line Memory Module (DIMM/SODIMM), proprietary interconnects . . . ).

User defined configuration parameters 112 may be pre-stored in a storage device (e.g. a flash or Electrical Erasable Programmable Read-Only Memory (EEPROM)) of pluggable host system 102. Configuration parameters 112 may include one or a combination of:

1. Number and types of IOs on the host system's pluggable interconnect interface (e.g., number and types of display interfaces (High Definition Multimedia Interface (HDMI), Digital Visual Interface (DVI), Display Port (DP), Video Graphics Array (VGA) . . . ), number of PCIE buses, number of USB or other serial buses on the host system.

2. Physical IO pins mapping (e.g., mapping of a set of physical IO pins between a PCI-E bus IO configuration; a Universal Serial Bus (USB) 3.0 IO configuration; or a Serial Advance Technology Attachment (SATA) bus IO configuration; HDMI I/O configuration, or a DP IO configuration, such as, HDMI signal set maps to PCIE pin #H1 to #Hn; or USB signal set maps to PCIE pin #P1 to #Pn . . . ).

3. Thermal Design Power (TDP) requirements.

4. Power requirements.

5. Any other parameters that may be used to optimize the combined system.

When pluggable computing device 104 is plugged into host system 102, pluggable computing device 104 may:

1. Read (operation A) platform parameters 112 from host system 102 using any suitable communication channel (e.g. PCIE pin #J to #K of the pluggable computing system may be configured to implement a serial bus protocol such as Serial Peripheral Interface Bus (SPI), Inter-Integrated Circuit (I2C) Bus or Universal Asynchronous Receiver/Transmitter (UART) to read an EEPROM or Flash memory of host system 102).

2. Store platform parameters 112 in a non-volatile memory region 106 (e.g. a Flash memory, or Static Random Access Memory (SRAM)) of pluggable computing device 104. In some embodiments, a PARAMETER_READ flag may be set after storing is done. In some embodiments, the non-volatile memory 106 may comprise of transitory memory blocks such as SRAM with control to ensure that its contents remained unchanged during system reset or reboot. For example: the non-volatile memory 106 may comprise of a SRAM memory block that is perpetually powered as long as the pluggable computing device 104 remains plugged into a host system, and its memory contents do not get automatically overwritten upon system reset or reboot.

3. In some embodiments, FW or BIOS 114 may first inspect the stored platform parameters to determine whether the parameters can be met (e.g. through software and device driver reconfiguration) without performing a sub-system reset or system reboot.

4. Thereafter, FW or BIOS 114 may invoke a sub-system reset or system reboot if it is required to meet platform parameters. In some embodiments, reset/reboot may be done with the help of host system 102. For example, pluggable computing device 104 may invoke host system 106 (operation B) to assert a reset/reboot signal and a PARAMETER_READ signal (operation C).

Upon sub-system reset or system reboot, pluggable computing device 104 may inspect the PARAMETER_READ flag or signal. If PARAMETER_READ flag or signal is asserted:
1. FW or BIOS 114 in the pluggable computing device 104 may resume the boot process using the platform parameters stored in its non-volatile memory region 106 to determine how to configure the combined system in order to meet the desired platform parameters of host system 102.
2. After booting is complete, pluggable computing device 104 may clear the PARAMETER_READ flag or invoke host system 102 to de-assert the PARAMETER_READ signal.

In some embodiments, configuration of the combined system may include, but is not limited to, configuration of the Mobile Industry Processor Interface (MIPI) Mixed-Signal Physical Layer (MPHY), a MIPI Display Physical Layer (DPHY) or a MIPI Camera Physical Layer (CPHY) of the IO pins for USB typed, PCIE typed, Display Bus Interface (DBI) typed, Display Serial Interface (DSI) typed, or a Camera Serial Interface (CSI) typed IO configurations; loading of device drivers; changing some of the underlying bus host controller interface (e.g., between a PCIE bus, a SATA bus, a USB bus, a display interface or a camera interface; or configuration of a subset of IO interfaces coupled to a USB type C or a PCIE interconnect.

In some embodiments, pluggable computing device 104 may also write another set of platform parameters to a non-volatile storage (not shown) of host system 102 before invoking host system 102 to assert a reset/reboot signal. These other set of platform parameters may include some power requirements to configure the host system's power delivery sub-system to increase/reduce power supplied to pluggable computing device 104.

In some embodiments, if no other platform parameter is used for pluggable systems configuration, the PARAMETER_READ signal can be pulled high (asserted) or the PARAMETER_READ flag can be perpetually set and the platform parameters in the non-volatile memory of the pluggable computing device may be set to NULL. Perpetually asserting the PARAMETER_READ signal or flag will cause the pluggable computing device to boot upon power on without reading any platform parameters from host system. A NULL platform parameter will further caused the pluggable computing device to boot based on a set of default platform parameters.

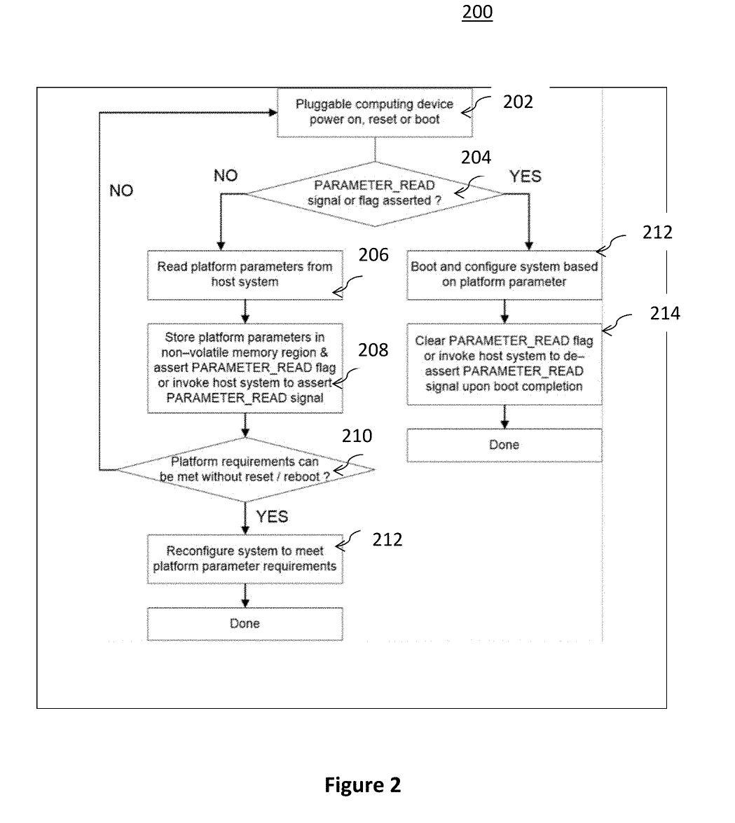

Referring now to FIG. 2 wherein a method view of the auto-configurable host pluggable computing, according to various other embodiments, is shown. As illustrated, process 200 for auto-configurable host pluggable computing may include operations performed at blocks 202-214. The operations may be performed e.g., by hardware, FW or BIOS 114 of pluggable computing device 104.

Process 200 may start at block 202. At block 202, pluggable computing device 104 may be powered on, reset or commence a boot process. Next, at 204, a determination may be made on whether the PARAMETER_READ flag or signal is asserted.

If a result of the determination indicates that the PARAMETER_READ flag or signal is not asserted, at block 206, platform parameters may be read from host system 102. Next, at block 208, the platform parameters may be stored in a non-volatile memory region of pluggable computing device 104, and thereafter, assert a PARAMETER_READ flag or invoke host system 102 to assert the PARAMETER_READ signal.

At block 210, a determination may be made on whether pluggable computing device can meet the platform requirements without reset/reboot. If a result of the determination is negative, process 200 returns to block 202, and continues therefrom as earlier described. From block 210, pluggable computing device may perform a self-reset or invoke host system to assert a reset or reboot signal to cause the process to return to block 202. If a result of the determination is positive, process 200 continues at block 212, where the pluggable computing device and/or the host system are/is configured to meet the platform parameter requirements.

Thereafter, process 200 may terminate.

Back at block 204, if a result of the determination indicates that the PARAMETER_READ flag or signal is asserted, process will continue at block 212. At block 212, the pluggable computing device and/or the host system may be boot and configured based on the platform parameters. Next, at block 214, the PARAMETER_READ flag may be cleared, or the host system may be invoked to de-assert the PARAMETER_READ signal upon boot completion.

Thereafter, process 200 may terminate.

Referring now to FIG. 3, wherein a component view of an example computer system formed by pluggable computing device 104 and host system 102, according to various embodiments, is illustrated. As shown, computer system 300 may include hardware 301 and software 303. In embodiments, hardware 301 may include one or more processors 302, memory 304, and communication interfaces 306, which may be components of pluggable computing device 104. In embodiments, hardware 301 may further include other devices 308, which may include components of pluggable computing device 104 or host system 102. Software 303 may include operating system (OS) 312 and application 314, which may be any one of such elements known in the art.

Processor(s) 302 may be any one of a number of processors known in the art, having one or more processor cores. Memory 304 may be any volatile or non-volatile memory known in the art, suitable for storing instructions and/or data, e.g., instructions and/or data of OS 312 and/or applications 314. Communication interfaces 306 may include any wired or wireless communication interfaces e.g., but are not limited to, Ethernet, WiFi, 3G/4G, Bluetooth®, Near Field Communication, Universal Serial Bus (USB) and so forth. Other devices 308 may include, but are not limited to, any number of devices known in the art, such as display, cameras, speakers, sensors, Global Positioning System (GPS), accelerometer, gyroscopes, and so forth

OS 312 may include a number of services and utilities 320. OS 312 may be any one of a number of OS known in the art, e.g., a Linux OS distribution, the Windows OS from Microsoft® Corporation, or the Android or Chrome OS from Google® Corporation.

As will be appreciated by one skilled in the art, aspects of the present disclosure may be embodied as methods or computer program products. Accordingly, aspects of the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, aspects of the present disclosure may take the form of a computer program product embodied in any tangible or non-transitory medium of expression having computer-usable program code embodied in the medium.

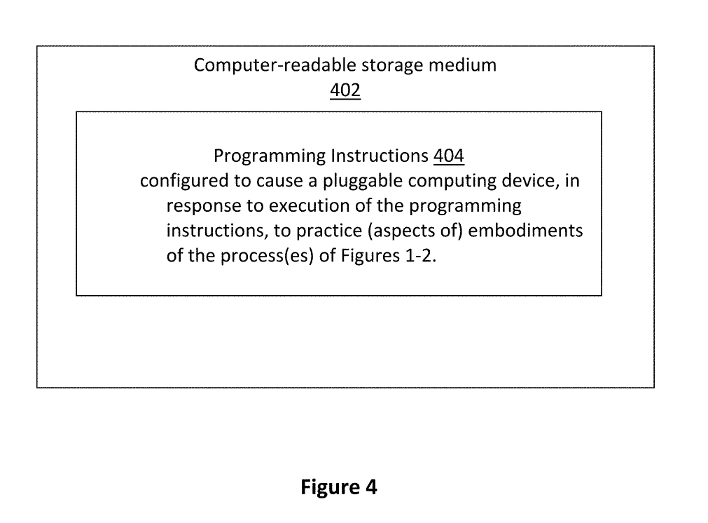

FIG. 4 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 402 may include a number of programming instructions 404. Programming instructions 404 may be configured to enable a pluggable computing device, e.g., pluggable computing device 104, in response to execution of the programming instructions, to implement (aspects of) FW or BIOS 114. In alternate embodiments, programming instructions 404 may be disposed on multiple computer-readable non-transitory storage media 402 instead. In still other embodiments, programming instructions 404 may be disposed on computer-readable transitory storage media 402, such as, signals.

Advantages:

The auto-configurable host pluggable computing technology enables effective eco-system scaling of pluggable computing systems. Different pluggable host system Original Equipment Manufacturers (OEMs) (e.g., pluggable display panel OEMs like NEC, Samsung, LG, BOE . . . ) may have different power, performance and IO requirements; for example: system TDP; display connections such as HDMI, DVI and DP; number of buses and IOs (e.g. number of external USB buses and serial buses . . . ), and physical IO pin mappings on display panel's pluggable interface (e.g. bus interface mappings on physical PCIE pins). For example: a pluggable display host from OEM A may have a DP interface, 1 USB interface and 1 PCIE interface; while a pluggable display host from OEM B may have 1 HDMI interface and 2 USB interfaces. A pluggable computing device OEM may utilize the invention to dynamically configure its device to support pluggable display panel configurations of both OEMs A & B based on which OEM's pluggable display panel the pluggable computing device is connected to.

The auto-configurable host pluggable computing technology enables pluggable systems to dynamically optimize its power, performance and IO compatibility between a pluggable computing device and its host system. For example: by knowing the TDP requirements of a host system during boot-up, a pluggable computing device may selectively cap its own performance parameters to prevent overheating. In some embodiments, pluggable computing device may also perform power negotiation with its pluggable host system to find a collective optimum system TDP.

The auto-configurable host pluggable computing technology enables pluggable systems to dynamically optimize its power, performance and IO compatibility between a pluggable computing device and its host system. For example: referencing the pluggable display panels from the example above. A pluggable computing system may selectively disable (e.g., power gate) its PCIE controller and PCIE IO buffers during boot-up to reduce overall power consumption when connected to pluggable display panel from OEM B with no PCIE bus IOs.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's wearable device, partly on the user's wearable device, as a stand-alone software package, partly on the user's wearable device and partly on a remote computer or entirely on the remote computer or server. In the latter scenario, the remote computer may be connected to the user's wearable device through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specifies the presence of stated features, integers, steps, operations, elements, and/or components, but do not preclude the presence or addition of one or more other features, integers, steps, operation, elements, components, and/or groups thereof.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Referring back to FIG. 3, for one embodiment, at least one of processors 302 may be packaged together with memory having programming instructions 404. For one embodiment, at least one of processors 302 may be packaged together with memory having aspects of programming instructions 404, to form a System in Package (SiP). For one embodiment, at least one of processors 302 may be integrated on the same die with memory having aspects of programming instructions 404. For one embodiment, at least one of processors 302 may be packaged together with memory having aspects of programming instructions 404, to form a System on Chip (SoC).

Thus, examples described include:

Example 1 may be a pluggable computing device, comprising: non-volatile memory; and firmware or basic input/output system (BIOS) to read a plurality of configuration parameters from a host system to which the pluggable computing device is plugged to, store the plurality of configuration parameters in the non-volatile memory, and reconfigure the pluggable computing device based at least in part on the stored configuration parameters; wherein reconfiguration of the pluggable computing device may include optimization of operation of the pluggable computing device or the host system.

Example 2 may be example 1, wherein the firmware or BIOS may read the plurality of configuration parameters from the host system, store the plurality of configuration parameters in the non-volatile memory, and invoke a platform sub-system reset or system reboot, on detection of the device being plugged to the host system; and wherein the firmware or BIOS may reconfigure the pluggable computing device based at least in part on the stored configuration parameters, on reset or reboot.

Example 3 may be example 1, may further comprise a physical interconnect interface to mate with a counterpart of the physical interconnect interface to plug the device to the host system.

Example 4 may be example 3, wherein the physical interconnect interface may comprise a peripheral component interconnect (PCI) express interface, a universal serial bus (USB) interface, or a Dual in-Line Memory Module/Small Outline Dual in-Line Memory Module (DIMM/SODIMM) interface.

Example 5 may be example 1, wherein the plurality of configuration parameters may include host system power requirements, host system Input/Output (IO) mappings, or host system performance requirements.

Example 6 may be example 5, wherein the plurality of configuration parameters may include number and types of display interfaces, number of peripheral component interconnect (PCI) express buses, number of Universal Serial Bus (USB) buses, or number of other serial buses on the host system.

Example 7 may be example 5, wherein the plurality of configuration parameters may include mapping of a set of physical IO pins between a Peripheral Component Interface Express (PCIE) bus IO configuration; a Universal Serial Bus (USB) 3.0 IO configuration; a Serial Advance Technology Attachment (SATA) bus IO configuration; a High Definition Media Interface (HDMI) IO configuration, or a Display Port (DP) IO configuration.

Example 8 may be example 1, wherein to optimize operation of the pluggable computing device or the host system may comprise to optimize thermal requirements or power consumption of the pluggable computing device or the host system.

Example 9 may be example 1, wherein to optimize operation of the pluggable computing device or the host system may comprise to optimize input/output (IO) compatibility between the pluggable computing device and its host system.

Example 10 may be example 1, wherein to optimize operation of the pluggable computing device or the host system may comprise configuration of Mobile Industry Processor Interface (MIPI) Mixed-Signal Physical Layer (MPHY), a MIPI Display Physical Layer (DPHY) or a MIPI Camera Physical Layer (CPHY) of input/output (IO) pins for Universal Serial Bus (USB) typed, Peripheral Component Interface Express (PCIE) typed, Display Bus Interface (DBI) type, Display Serial Interface (DSI) type, or a Camera Serial Interface (CSI) type IO configurations; loading of device drivers; changing underlying bus host controller interface between a PCIE bus a Serial Advance Technology Attachment (SATA) bus, a Universal Serial Bus (USB), a display interface, or a camera interface; or configuration of a subset of IO interfaces coupled to a USB type C or a PCIE interconnect.

Example 11 may be any one of examples 1-10, wherein the device may be a selected one of an Open Pluggable Specification (OPS) compute module, a graphics processor unit (GPU) card, a compute stick, or a processor on a Peripheral Component Interconnect (PCI) Express processor card module.

Example 12 may be any one of examples 1-10, wherein the host system may be a pluggable display panel or a pluggable embedded computing system.

Example 13 may be a method for pluggable computing, comprising: reading, by a pluggable computing device, configuration parameters from a host system to which the pluggable computing device is plugged to; storing, by the pluggable computing device, the configuration parameters in a non-volatile memory of the pluggable computing device; invoking, by the pluggable computing device, a platform sub-system reset or system reboot; and on reset or system reboot, reconfiguring, by the pluggable computing device, the pluggable computing device based on the stored configuration parameters to optimize operation of the pluggable computing device or the host system.

Example 14 may be example 13, may further comprise detecting for the device being plugged to the host system; wherein said reading, storing and invoking are performed on detecting the device being plugged to the host system.

Example 15 may be example 13, wherein the plurality of configuration parameters may include host system power requirements, host system Input/Output (IO) mappings, or host system performance requirements.

Example 16 may be example 15, wherein the plurality of configuration parameters may include number and types of display interfaces, number of peripheral component interconnect (PCI) express buses, number of Universal Serial Bus (USB) buses, or number of other serial buses on the host system.

Example 17 may be example 15, wherein the plurality of configuration parameters may include mapping of a set of physical IO pins between a Peripheral Component Interface Express (PCIE) bus IO configuration; a Universal Serial Bus (USB) 3.0 IO configuration; a Serial Advance Technology Attachment (SATA) bus IO configuration; a High Definition Media Interface (HDMI) IO configuration, or a Display Port (DP) IO configuration.

Example 18 may be example 13-17, wherein reconfiguring may comprise inspecting the stored configuration parameters for host system requirements, and guiding a platform configuration process or boot sequence, including optimizing operation of the pluggable computing device or the host system, using this information.

Example 19 may be example 18, wherein optimizing operation of the pluggable computing device or the host system may comprise optimizing thermal requirements or power consumption of the pluggable computing device or the host system.

Example 20 may be example 18, wherein optimizing operation of the pluggable computing device or the host system may comprise optimizing input/output (IO) compatibility between the pluggable computing device and its host system.

Example 21 may be example 18, wherein optimizing operation of the pluggable computing device or the host system may comprise configuring a Mobile Industry Processor Interface (MIPI) Mixed-Signal Physical Layer (MPHY), a MIPI Display Physical Layer (DPHY) or a MIPI Camera Physical Layer (CPHY) of input/output (IO) pins for Universal Serial Bus (USB) typed, Peripheral Component Interface Express (PCIE) typed, Display Bus Interface (DBI) type, Display Serial Interface (DSI) type, or a Camera Serial Interface (CSI) type IO configurations; loading device drivers; changing underlying bus host controller interface between a PCIE bus a Serial Advance Technology Attachment (SATA) bus, a USB Bus, a display interface, or a camera interface; or configuring a subset of IO interfaces coupled to a USB type C or a PCIE interconnect.

Example 22 may be one or more computer-readable storage medium comprising a plurality of instructions, in response to execution of the instructions by a pluggable computing device, to cause the device to: read configuration parameters from a host system to which the pluggable computing device is plugged to, store the configuration parameters in non-volatile memory, and reconfigure the pluggable computing device based on the configuration parameters to optimize operation of the pluggable computing device or the host system.

Example 23 may be example 22, wherein the pluggable computing device may be further caused to detect for the device being plugged to the host system; wherein said read and store are performed on detection of the device being plugged to the host system, and wherein the pluggable computing device is further caused to invoke a platform sub-system reset or system reboot on performance of said read and store; wherein said reconfigure is performed after the reset or reboot.

Example 24 may be example 22, wherein the plurality of configuration parameters may include host system power requirements, host system Input/Output (IO) mappings, or host system performance requirements.

Example 25 may be example 24, wherein the plurality of configuration parameters may include number and types of display interfaces, number of peripheral component interconnect (PCI) express buses, number of Universal Serial Bus (USB) buses, or number of other serial buses on the host system.

Example 26 may be example 24, wherein the plurality of configuration parameters may include mapping of a set of physical IO pins between a Peripheral Component Interface Express (PCIE) bus IO configuration; a Universal Serial Bus (USB) 3.0 IO configuration; a Serial Advance Technology Attachment (SATA) bus IO configuration; a High Definition Media Interface (HDMI) IO configuration, or a Display Port (DP) IO configuration.

Example 27 may be any one of examples 22-26, wherein to reconfigure may comprise to inspect the stored configuration parameters for host system requirements, and to guide a platform configuration process or boot sequence, including optimization of operation of the pluggable computing device or the host system, using this information.

Example 28 may be example 27, wherein to optimize operation of the pluggable computing device or the host system may comprise optimization of thermal requirements or power consumption of the pluggable computing device or the host system.

Example 29 may be example 27, wherein to optimize operation of the pluggable computing device or the host system may comprise to optimize input/output (IO) compatibility between the pluggable computing device and its host system.

Example 30 may be example 27, wherein to optimize operation of the pluggable computing device or the host system may comprise to configure a Mobile Industry Processor Interface (MIPI) Mixed-Signal Physical Layer (MPHY), a MIPI Display Physical Layer (DPHY) or a MIPI Camera Physical Layer (CPHY) of input/output (IO) pins for Universal Serial Bus (USB) typed or Peripheral Component Interface Express (PCIE) typed, Display Bus Interface (DBI) type, Display Serial Interface (DSI) type, or a Camera Serial Interface (CSI) type IO configurations; to load device drivers; to change underlying bus host controller interface between a PCIE bus, a Serial Advance Technology Attachment (SATA) bus, a USB bus, a display interface, or a camera interface; or to configure a subset of IO interfaces coupled to a USB type C or a PCIE interconnect.

Example 31 may be an apparatus for pluggable computing, comprising: means for reading configuration parameters from a host system to which the pluggable computing device is plugged to; means for storing the configuration parameters in a non-volatile memory; means for invoking a platform sub-system reset or system reboot; and means for reconfiguring, on reset or system reboot, the pluggable computing device based on the stored configuration parameters to optimize operation of the pluggable computing device or the host system.

Example 32 may be example 31, may further comprise means for detecting for the device being plugged to the host system; wherein said means for reading, storing, and invoking respectively performs said reading, storing and invoking in response to said means for detecting, detecting the device being plugged to the host system.

Example 33 may be example 31, wherein the plurality of configuration parameters may include host system power requirements, host system Input/Output (IO) mappings, or host system performance requirements.

Example 34 may be example 33, wherein the plurality of configuration parameters may include number and types of display interfaces, number of peripheral component interconnect (PCI) express buses, number of Universal Serial Bus (USB) buses, or number of other serial buses on the host system.

Example 35 may be example 33, wherein the plurality of configuration parameters may include mapping of a set of physical IO pins between a Peripheral Component Interface Express (PCIE) bus IO configuration; a Universal Serial Bus (USB) 3.0 IO configuration; a Serial Advance Technology Attachment (SATA) bus IO configuration; a High Definition Media Interface (HDMI) IO configuration, or a Display Port (DP) IO configuration.

Example 36 may be any one of examples 31-35, wherein means for reconfiguring may comprise means for inspecting the stored configuration parameters for host system requirements, and means for guiding a platform configuration process or boot sequence, including means for optimizing operation of the pluggable computing device or the host system, using this information.

Example 37 may be example 36, wherein means for optimizing operation of the pluggable computing device or the host system may comprise means for optimizing thermal requirements or power consumption of the pluggable computing device or the host system.

Example 38 may be example 36, wherein means for optimizing operation of the pluggable computing device or the host system may comprise means for optimizing input/output (IO) compatibility between the pluggable computing device and its host system.

Example 39 may be example 36, wherein means for optimizing operation of the pluggable computing device or the host system may comprise means for configuring a Mobile Industry Processor Interface (MIPI) Mixed-Signal Physical Layer (MPHY), a MIPI Display Physical Layer (DPHY) or a MIPI Camera Physical Layer (CPHY) of input/output (IO) pins for Universal Serial Bus (USB) typed or Peripheral Component Interface Express (PCIE) typed, Display Bus Interface (DBI) type, Display Serial Interface (DSI) type, or a Camera Serial Interface (CSI) type IO configurations; means for loading device drivers; means for changing underlying bus host controller interface between a PCIE bus, a Serial Advance Technology Attachment (SATA) bus, a Universal Serial Bus, a display interface, or a camera interface; or means for configuring a subset of IO interfaces coupled to a USB type C or a PCIE interconnect.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A pluggable computing device, comprising:
non-volatile memory; and
firmware or basic input/output system (BIOS) to read a plurality of configuration parameters from a host system to which the pluggable computing device is plugged to, store the plurality of configuration parameters in the non-volatile memory, and reconfigure the pluggable computing device based at least in part on the stored configuration parameters;
wherein reconfiguration of the pluggable computing device includes optimization of operation of the pluggable computing device or the host system.

2. The device of claim 1, wherein the firmware or BIOS is to read the plurality of configuration parameters from the host system, store the plurality of configuration parameters in the non-volatile memory, and invoke a platform sub-system reset or system reboot, on detection of the device being plugged to the host system; and wherein the firmware or BIOS is to reconfigure the pluggable computing device based at least in part on the stored configuration parameters, on reset or reboot.

3. The device of claim 1, further comprise a physical interconnect interface to mate with a counterpart of the physical interconnect interface to plug the device to the host system.

4. The device of claim 3, wherein the physical interconnect interface comprises a peripheral component interconnect (PCI) express interface, a universal serial bus (USB) interface, or a Dual in-Line Memory Module/Small Outline Dual in-Line Memory Module (DIMM/SODIMM) interface.

5. The device of claim 1, wherein the plurality of configuration parameters include host system power requirements, host system Input/Output (IO) mappings, or host system performance requirements.

6. The device of claim 5, wherein the plurality of configuration parameters include number and types of display interfaces, number of peripheral component interconnect (PCI) express buses, number of Universal Serial Bus (USB) buses, or number of other serial buses on the host system.

7. The device of claim 5, wherein the plurality of configuration parameters include mapping of a set of physical IO pins between a Peripheral Component Interface Express (PCIE) bus IO configuration; a Universal Serial Bus (USB) 3.0 IO configuration; a Serial Advance Technology Attachment (SATA) bus IO configuration; a High Definition Media Interface (HDMI) IO configuration, or a Display Port (DP) IO configuration.

8. The device of claim 1, wherein to optimize operation of the pluggable computing device or the host system comprises to optimize thermal requirements or power consumption of the pluggable computing device or the host system.

9. The device of claim 1, wherein to optimize operation of the pluggable computing device or the host system comprises to optimize input/output (IO) compatibility between the pluggable computing device and its host system.

10. The device of claim 1, wherein to optimize operation of the pluggable computing device or the host system comprises configuration of Mobile Industry Processor Interface (MIPI) Mixed-Signal Physical Layer (MPHY), a MIPI Display Physical Layer (DPHY) or a MIPI Camera Physical Layer (CPHY) of input/output (IO) pins for Universal Serial Bus (USB) typed, Peripheral Component Interface Express (PCIE) typed, Display Bus Interface (DBI) type, Display Serial Interface (DSI) type, or a Camera Serial Interface (CSI) type IO configurations; loading of device drivers; changing underlying bus host controller interface between a PCIE bus a Serial Advance Technology Attachment (SATA) bus, a Universal Serial Bus (USB), a display interface, or a camera interface; or configuration of a subset of IO interfaces coupled to a USB type C or a PCIE interconnect.

11. The device of claim 1, wherein the device is a selected one of an Open Pluggable Specification (OPS) compute module, a graphics processor unit (GPU) card, a compute stick, or a processor on a Peripheral Component Interconnect (PCI) Express processor card module.

12. The device of claims claim 1, wherein the host system is a pluggable display panel or a pluggable embedded computing system.

13. A method for pluggable computing, comprising:
reading, by a pluggable computing device, configuration parameters from a host system to which the pluggable computing device is plugged to;
storing, by the pluggable computing device, the configuration parameters in a non-volatile memory of the pluggable computing device;
invoking, by the pluggable computing device, a platform sub-system reset or system reboot; and
on reset or system reboot, reconfiguring, by the pluggable computing device, the pluggable computing device based on the stored configuration parameters to optimize operation of the pluggable computing device or the host system.

14. The method of claim 13, further comprises detecting for the device being plugged to the host system; wherein said reading, storing and invoking are performed on detecting the device being plugged to the host system.

15. The method of claim 13, wherein the plurality of configuration parameters include host system power requirements, host system Input/Output (IO) mappings, or host system performance requirements.

16. The method of claim 13, wherein reconfiguring comprises inspecting the stored configuration parameters for host system requirements, and guiding a platform configuration process or boot sequence, including optimizing operation of the pluggable computing device or the host system, using this information.

17. The method of claim 16, wherein optimizing operation of the pluggable computing device or the host system comprises optimizing thermal requirements or power consumption of the pluggable computing device or the host system.

18. The method of claim 16, wherein optimizing operation of the pluggable computing device or the host system comprises optimizing input/output (IO) compatibility between the pluggable computing device and its host system.

19. One or more computer-readable storage medium comprising a plurality of instructions, in response to execution of the instructions by a pluggable computing device, to cause the device to:
read configuration parameters from a host system to which the pluggable computing device is plugged to, store the configuration parameters in non-volatile memory, and reconfigure the pluggable computing device based on the configuration parameters to optimize operation of the pluggable computing device or the host system.

20. The computer-readable storage medium of claim 19, wherein the pluggable computing device is further caused to detect for the device being plugged to the host system; wherein said read and store are performed on detection of the device being plugged to the host system, and wherein the pluggable computing device is further caused to invoke a platform sub-system reset or system reboot on performance of said read and store; wherein said reconfigure is performed after the reset or reboot.

21. The computer-readable storage medium of claim 19, wherein the plurality of configuration parameters include host system power requirements, host system Input/Output (IO) mappings, or host system performance requirements.

22. The computer-readable storage medium of claim 21, wherein the plurality of configuration parameters include number and types of display interfaces, number of peripheral component interconnect (PCI) express buses, number of Universal Serial Bus (USB) buses, or number of other serial buses on the host system.

23. The computer-readable storage medium of claim 21, wherein the plurality of configuration parameters include mapping of a set of physical IO pins between a Peripheral Component Interface Express (PCIE) bus IO configuration; a Universal Serial Bus (USB) 3.0 IO configuration; a Serial Advance Technology Attachment (SATA) bus IO configuration; a High Definition Media Interface (HDMI) IO configuration, or a Display Port (DP) IO configuration.

24. The computer-readable storage medium of claim 19, wherein to reconfigure comprises to inspect the stored configuration parameters for host system requirements, and to guide a platform configuration process or boot sequence, including optimization of operation of the pluggable computing device or the host system, using this information.

25. The computer-readable storage medium of claim 24, wherein to optimize operation of the pluggable computing device or the host system comprises optimization of thermal requirements or power consumption of the pluggable computing device or the host system, or input/output (IO) compatibility between the pluggable computing device and its host system.
